(19) United States
(12) Patent Application Publication
(10) Pub. No.: US 2005/0208357 A1
(43) Pub. Date: Sep. 22, 2005

(54) Fuel cell hybrid pump-ejector fuel recycle system

(76) Inventors: Alan S. Bitzer, Weatogue, CT (US); Albert P. Grasso, Vernon, CT (US)

Correspondence Address: M.P. Williams, 210 Main Street, Manchester, CT, 06040, US

(21) Appl. No.: 10/802,017

(22) Filed: Mar. 16, 2004

(51) Int. Cl. H01M 8/04; H01M 8/02

(52) U.S. Cl. 429/34; 429/38; 429/25

(57) ABSTRACT

Fuel cell flow fields (7) have their outlets (23) connected through a low pressure blower (19) to a secondary inlet (31) of an ejector (17), the output of the ejector being connected to the inlets (9) of the fuel flow fields. A high pressure source of hydrogen (14) passes through a remote-sense pressure control valve, thereby causing the correct amount of fuel to flow to the primary inlet (30) of the ejector, in dependence upon the load of the fuel cell stack, to cause the pressure at the fuel inlets (9), or alternatively the fuel outlets (23), to be constant. The blower is selected to provide adequate fuel recycle gas in a range of low power fuel cell stack operation which includes the lowest power operation of the fuel cell stack. The ejector draws fuel recycle gas in excess of the blower maximum. A bypass valve (36) permits the ejector to carry less than maximum fuel.

### TECHNICAL FIELD

This invention relates to a fuel recycle system in a fuel cell power plant which employs both a blower (for low level flow) and an ejector (for high level flow), and optionally, a pressure relief valve bypassing the ejector for even higher level flow.

### BACKGROUND ART

To achieve fuel utilization approaching 100% in fuel cell power plants, without fuel starvation in diverse parts of some of the fuel cells, which can cause corrosion of the carbonaceous catalyst supports and overall fuel cell performance degradation, it is common to recycle a portion of the fuel exiting from the fuel cell fuel flow fields. In this way, an adequate supply of hydrogen is assured throughout all of the fuel cells, and the humidification of the incoming fuel is improved.

As the hydrogen concentration is depleted, the concentration of inert gases in the fuel recycle gas, such as nitrogen resulting from consumption of hydrogen and crossover or diffusion through the porous membrane electrolyte from the cathode gas stream, will continue to increase until it reaches equilibrium within the cell. To reduce the inert gas level at the anode, purging of some of the fuel gas exiting the fuel flow fields is commonly used.

Since there is a pressure drop across the fuel cell flow fields, the fuel recycle gas must be pressurized in order to flow from the exits to the inlets of the flow fields.

It has been common to employ fuel recycle pumps for this purpose. Due to the low density of the hydrogen gas in the fuel stream, these pumps operate at very high speeds (in excess of 20,000 rpm) which is detrimental to the bearings operating in a harsh, wet hydrogen environment. Furthermore, high speed recycle pumps typically have a high frequency noise problem, and the electricity consumed by the recycle pumps, referred to as parasitic power, reduces the overall efficiency of a fuel cell power plant.

To avoid problems with fuel recycle pumps, ejectors have been utilized. However, it is difficult to size ejector devices to cover the wide range of recycle flows, particularly as are attendant vehicular applications (such as powering electric cars).

### DISCLOSURE OF INVENTION

Objects of the invention include: elimination of high speed recycle blowers; reducing noise in a fuel recycle system; rendering use of an ejector in a fuel recycle system practical; and an improved fuel recycle system for a fuel cell power plant.

According to the present invention, the recycle fuel flow in a fuel cell power plant is driven by both a low speed blower, which assures a minimum recycle flow at the lowest power levels, and an ejector which draws the fuel recycle gas from the fuel flow field outlets back to the fuel flow field inlets at the higher power levels.

In further accord with the present invention, a remote-sense fuel pressure regulator is used to regulate the fuel flow upstream of the ejector in a manner to attain a constant fuel pressure at the inlets (in one embodiment) or the outlets (in another embodiment) of the fuel flow fields, downstream of the ejector.

A pressure relief valve may bypass the ejector to deliver fuel when the demand therefore exceeds the flow choke point of the ejector.

Although the invention is described in relation to fuel reactant gas with respect to the anode flow fields of a fuel cell stack, it may be applied to oxidant reactant gas with respect to the cathode flow fields.

The invention permits taking advantage of the simplicity and effectiveness of an ejector at fuel flow rates which are capable of operating the ejector, eliminating the need for very high speed pumps, and permits use of a low speed blower to handle fuel recycle requirements at low power levels.

Other objects, features and advantages of the present invention will become more apparent in the light of the following detailed description of exemplary embodiments thereof, as illustrated in the accompanying drawing.

### BRIEF DESCRIPTION OF THE DRAWINGS

FIG. 1 is a simplified schematic diagram of fuel flow fields of a fuel cell power plant with a fuel recycle system according to the present invention, with fuel control at the fuel flow field inlets.

FIG. 2 is a simplified schematic diagram of fuel flow fields of a fuel cell power plant with a fuel recycle system according to the present invention, with fuel control at the fuel flow field outlets.

### MODE(S) FOR CARRYING OUT THE INVENTION

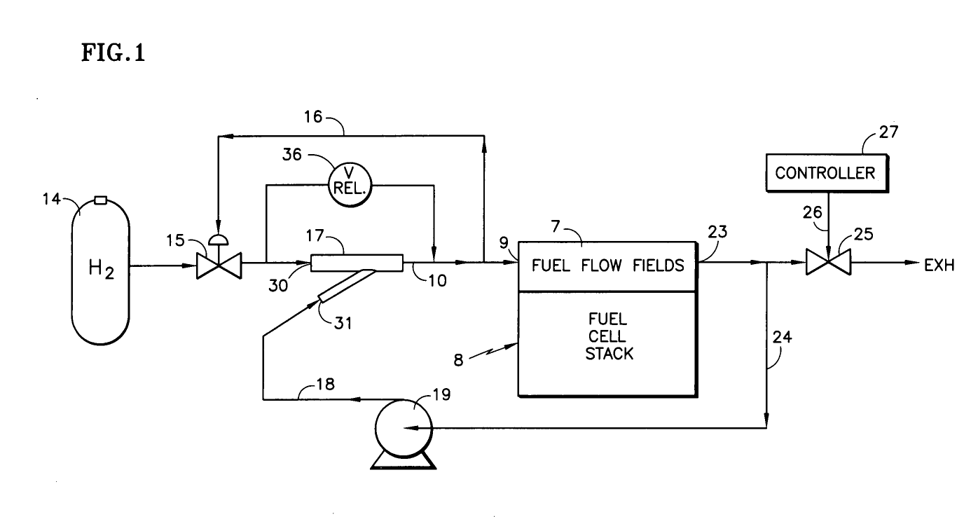

Referring to FIG. 1, the fuel flow fields 7 of a fuel cell stack 8 receive fuel at inlets 9 via a conduit 10. A source of hydrogen 14 (which could be a conventional reformer or a tank of liquid or gaseous hydrogen) provides fuel to a remote-sense pressure regulator 15, the sensed pressure of which, in a line 16, is that in the conduit 10 at the inlet of the fuel flow fields. The pressure regulator provides neat hydrogen to an ejector 17, which draws recycle fuel through a recycle conduit 18 from a pump 19. The pressure regulator 15 senses lower pressure at the inlet 9 whenever an increased load causes more fuel to be consumed, and responds by providing more fuel to the ejector 17 (and vice versa). The pump is connected to the fuel flow field exits 23 by a conduit 24, which also provides exiting fuel to a purge valve 25 which responds to a control signal 26 from a controller 27. Purging a portion of the exiting fuel gas, in a conventional way, reduces the concentration of inert gases, such as nitrogen which diffuses through the porous membrane electrolyte from the cathode gas stream.

At the lowest power levels of operation, the pump 19, which operates continuously, will provide the required fuel recycle gas through the ejector 17 and into the fuel flow fields 7. As the power level increases, the ejector 17 will have at its primary input 30, a sufficient flow so as to begin to draw recycle gas through its secondary input 31. At some point, the amount of gas being drawn into the secondary input 31 will exceed the amount of gas being impelled by the pump itself, and fuel recycle gas will be drawn through the pump in excess of any amount that the pump itself could provide. At the highest power levels, the ejector 17 will be drawing fuel recycle gas right through the blower 19, unaffected by the blower since the blower is a slow, low power centrifugal blower and provides very little resistance to the flow of the fuel recycle gas being drawn therethrough by the ejector.

In accordance with the invention, the ejector 17 is sized to draw fuel recycle gas right through the blower 19 from the conduit 24 at all but the lowest power levels of the fuel cell stack. In accordance with the invention, the blower 19 is a low speed, low pressure rise (head) centrifugal blower which will provide adequate recycle at the lowest power levels of the fuel cell stack.

The ejector design is optimized for the full power range of the intended application. The ejector need not provide a proportional amount of recycle at the highest fuel utilizations. Therefore, the system can operate with flow of fuel which exceeds the choke flow of the ejector, the amount of bypass flow being adequate for even greater loads. This is accomplished by a pressure relief valve 36 that opens just below a pressure which will choke the ejector 31. Therefore, the ejector may be designed for a lessor flow range: not needing to draw recycle at the lowest flows which are handled by the blower, and not needing to pass fresh hydrogen above an amount that satisfies the recycle required for maximum rated fuel utilization, due to the bypass 36.

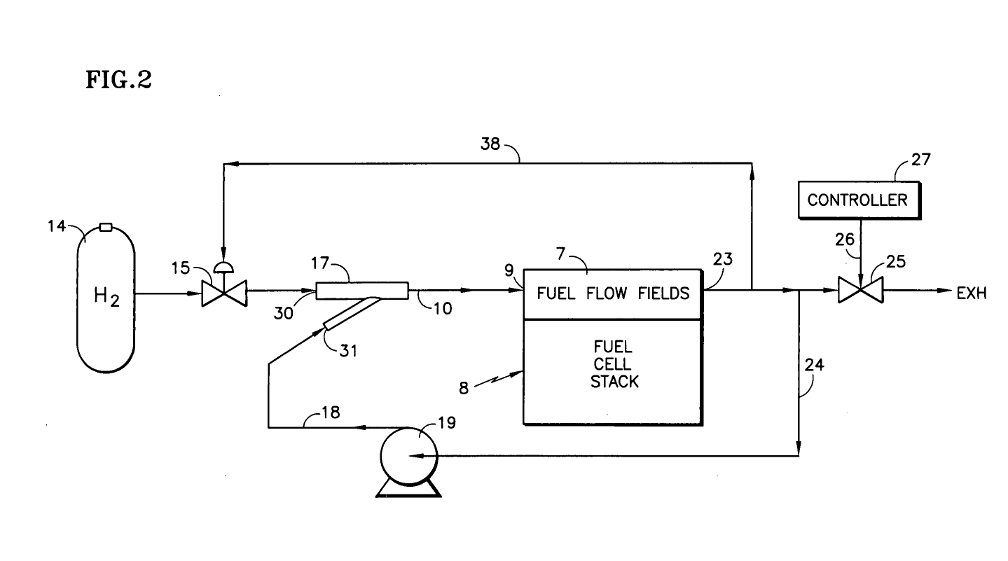

In a second embodiment, illustrated in FIG. 2, the sensing line 38 for the remote-sense pressure regulator 15 is connected to the fuel flow field outlets 23. This configuration provides a quicker response to increased consumption of fuel.

FIG. 2 also illustrates use of a full power ejector, with no bypass (36) of the type described with respect to FIG. 1.

The invention significantly reduces the amount of electricity required for driving the fuel recycle gas. The invention eliminates high speed recycle gas pump operation, thereby eliminating noise.

Thus, although the invention has been shown and described with respect to exemplary embodiments thereof, it should be understood by those skilled in the art that the foregoing and various other changes, omissions and additions may be made therein and thereto, without departing from the spirit and scope of the invention.

1. (canceled)

2. A fuel cell power plant comprising:
a stack of fuel cells, each of said fuel cells having a reactant gas flow field with an inlet and an outlet;
a source of pressurized reactant gas;
an ejector having a primary inlet interconnected with said source of reactant gas, having a secondary inlet, and having an outlet, the outlet of said elector being connected to the inlets of said reactant gas flow fields; and
a blower having an inlet and an outlet, the inlet of said blower being connected with the outlets of said reactant gas flow fields, the outlet of said blower being connected to the secondary inlet of said ejector;
said ejector primary inlet interconnected with said source of reactant gas through a remote-sense pressure regulator which regulates the pressure of reactant gas at said primary inlet in response to the pressure of reactant gas at said reactant gas flow field inlets.

3. A fuel cell power plant comprising:
a stack of fuel cells, each of said fuel cells having a reactant gas flow field with an inlet and an outlet;
a source of pressurized reactant gas;
an ejector having a primary inlet interconnected with said source of reactant gas, having a secondary inlet, and having an outlet, the outlet of said ejector being connected to the inlets of said reactant gas flow fields; and
a blower having an inlet and an outlet, the inlet of said blower being connected with the outlets of said reactant gas flow fields, the outlet of said blower being connected to the secondary inlet of said ejector;
said ejector primary inlet interconnected with said source of reactant gas through a remote-sense pressure regulator which regulates the pressure of reactant gas at said primary inlet in response to the pressure of reactant gas at said reactant gas flow field outlets.

4. (canceled)

5. (canceled)
